(19) United States
(12) Patent Application Publication
(10) Pub. No.: US 2024/0128886 A1
(43) Pub. Date: Apr. 18, 2024

(54) POWER SUPPLY DEVICE

(71) Applicant: Panasonic Intellectual Property Management Co., Ltd., Osaka (JP)

(72) Inventors: Hiromu MATSUMOTO, Osaka (JP); Hiroyuki HOSOI, Osaka (JP)

(21) Appl. No.: 18/467,507

(22) Filed: Sep. 14, 2023

(30) Foreign Application Priority Data
Oct. 17, 2022 (JP) 2022-166450

(51) Int. Cl. H02M 7/04

(52) U.S. Cl. CPC H02M 7/04

(57) ABSTRACT

A power supply device is connectable to a single-phase AC power supply or a multi-phase AC power supply. The power supply device includes power conversion circuits, a relay circuit, and a processor. The relay circuit is capable of switching between a first state and a second state. In the first state, a power supply line of each phase of the multi-phase AC power supply is connected to a corresponding power conversion circuit. In the second state, a power supply line of the single-phase AC power supply is connected to two or more of the power conversion circuits. The processor controls output timing of a control signal for operating the relay circuit on the basis of a detected temperature. The output timing is controlled such that, the first state is switched to the second state at timing when an AC voltage of the single-phase AC power supply crosses zero.

### CROSS-REFERENCE TO RELATED APPLICATIONS

This application is based upon and claims the benefit of priority from Japanese Patent Application No. 2022-166450, filed on Oct. 17, 2022, the entire contents of which are incorporated herein by reference.

### FIELD

The present disclosure relates generally to a power supply device.

### BACKGROUND

In the related art, a power supply device has been known. The power supply device serves to convert AC power from a single-phase AC power supply or a multi-phase AC power supply into DC power. Such a power supply device includes, for example, three power conversion circuits corresponding to phases of a three-phase AC power supply on a one-to-one basis. When the power supply device is connected to the three-phase AC power supply, each phase of the three-phase AC power supply is connected to a corresponding power conversion circuit.

Moreover, when the power supply device is connected to a single-phase AC power supply, a relay circuit is activated to connect at least two of the power conversion circuits to the single-phase AC power supply. This configuration increases the rated capacity of the power supply device at the time of connection with a single-phase AC power supply.

In this type of power supply device, there is a proposed device that protects a relay circuit by suppressing an inrush current that flows at the time of switching the relay circuit (for example, JP 2021-164166 A). This power supply device controls the output timing of a control signal in such a manner that the relay circuit is switched close to a zero-cross point of the AC voltage when a single-phase AC power supply is connected. As a result, an inrush current flowing into the relay circuit is suppressed without providing an inrush current preventing circuit.

Meanwhile, the operation time of a relay circuit used in a power supply device varies with the state of the actual use (hereinafter, also referred to as “actual use state”) such as the ambient temperature or aging of the relay.

However, in the conventional power supply devices, variations in the operation time due to an actual use state are not considered, and thus there is room for improvement in this respect. The operation time refers to a time period from output of a control signal for controlling the relay circuit to switching of the relay circuit.

### SUMMARY

A power supply device according to one embodiment of the present disclosure is connectable to a single-phase AC power supply or a multi-phase AC power supply. The power supply device includes power conversion circuits, a relay circuit, noise filter circuits, temperature detection circuit, and a hardware processor. Each of the power conversion circuits corresponds to a different one of phases of the multi-phase AC power supply. The relay circuit is capable of switching between a first state and a second state. The first state is a state where a power supply line of each of the phases of the multi-phase AC power supply is connected to a corresponding power conversion circuit. The second state is a state where a power supply line of the single-phase AC power supply is connected to at least two of the power conversion circuits. Each of the noise filter circuits includes a capacitor and is positioned closer to the power conversion circuits than the relay circuit is. Each of the noise filter circuits corresponds to a different one of the power conversion circuits. The temperature detection circuit is configured to detect a temperature of the relay circuit. The hardware processor is configured to control output timing of a control signal for operating the relay circuit on the basis of the temperature detected by the temperature detection circuit. The output timing is controlled such that, the first state is switched to the second state at timing when an AC voltage of the single-phase AC power supply crosses zero.

### BRIEF DESCRIPTION OF THE DRAWINGS

FIG. 1 is a diagram illustrating a configuration example of a power supply device according to a first embodiment;

FIG. 2 is a diagram for explaining a case where a relay is switched at timing shifted from a zero-cross point of an AC voltage;

FIG. 3 is a diagram for explaining a case where a relay is switched at a zero-cross point of the AC voltage;

FIG. 4 is a diagram for explaining occurrence of an inrush current in the first embodiment;

FIG. 5 is a graph illustrating operation time temperature characteristics of each individual relay used in the power supply device according to the first embodiment;

FIG. 6 is a table illustrating temperature characteristic information stored in a storage unit of the power supply device according to the first embodiment;

FIG. 7 is a block diagram illustrating the functional configuration of a control unit of the power supply device according to the first embodiment;

FIG. 8 is a flowchart illustrating a flow of relay switching processing by the control unit of the power supply device according to the first embodiment;

FIG. 9 is a diagram for explaining occurrence of an inrush current in a second embodiment;

FIG. 10 is a block diagram illustrating the functional configuration of a control unit of a power supply device according to the second embodiment; and

FIG. 11 is a flowchart illustrating a flow of relay switching processing by the control unit of the power supply device according to the second embodiment.

### DETAILED DESCRIPTION

Hereinafter, embodiments of the present disclosure will be described in detail with reference to the drawings.

### First Embodiment

A power supply device 100 according to a first embodiment will be described. A power supply device 100 is used for, for example, a charging device of a vehicle such as an electric vehicle, a hybrid vehicle, or a motorcycle. The power supply device 100 can be connected to a single-phase AC power supply or a three-phase AC power supply.

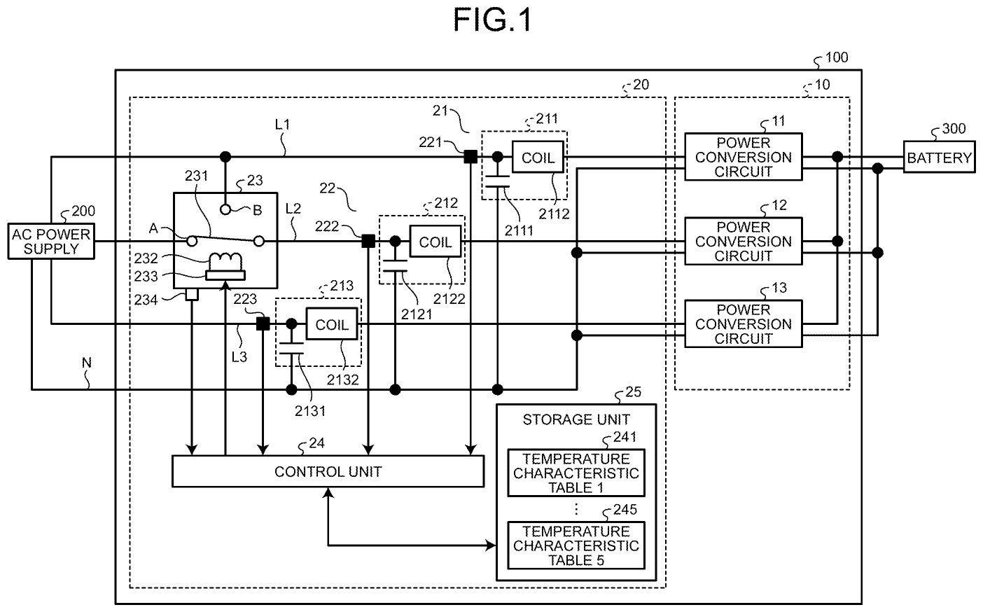

FIG. 1 is a diagram illustrating a configuration example of the power supply device 100. The power supply device 100 is a device that converts AC power from a single-phase or three-phase AC power supply 200 into DC power, and outputs the DC power to a battery 300 as a load.

The battery 300 is, for example, a battery for driving a vehicle motor. The battery 300 is a high-voltage battery and is, for example, a lithium-ion battery. Note that the load connected to the power supply device 100 may be, for example, a battery used for items other than a vehicle, such as a home appliance, or may be a load other than batteries.

The power supply device 100 includes a power conversion unit 10 and a conversion circuit switching unit 20. The power conversion unit 10 converts AC power from the AC power supply 200 into DC power. The conversion circuit switching unit 20 switches the operation of the power conversion unit 10 depending on whether the AC power supply to be connected is a single-phase AC power supply or a three-phase AC power supply.

The power conversion unit 10 includes a first power conversion circuit 11, a second power conversion circuit 12, and a third power conversion circuit 13. The power conversion circuits 11 to 13 correspond to phases of the three-phase AC power supply on a one-to-one basis. Specifically, in a case where the AC power supply 200 is a three-phase AC power supply, the first power conversion circuit 11 is connected to a power supply line L1 to which a first-phase AC voltage is applied. The second power conversion circuit 12 is connected to a power supply line L2 to which a second-phase AC voltage is applied. Similarly, the third power conversion circuit 13 is connected to a power supply line L3 to which a third-phase AC voltage is applied. Note that each of the power conversion circuits 11 to 13 is also connected to a power supply line that is a neutral wire N.

In a case where the AC power supply 200 is a single-phase AC power supply, the first power conversion circuit 11 is connected to the power supply line L1 to which an AC voltage of the single-phase AC power supply is applied. The second power conversion circuit 12 is connected to the power supply line L1 via the power supply line L2. The third power conversion circuit 13 is not connected to the power supply line L1. In other words, in a case where the AC power supply 200 is a single-phase AC power supply, the first power conversion circuit 11 and the second power conversion circuit 12 are connected to the AC power supply 200, whereas the third power conversion circuit 13 is not connected to the AC power supply 200.

When the single-phase AC power supply is connected, the rated capacity of the power supply device 100 at the time when the single-phase AC power supply is connected thereto can be increased by operating the power conversion circuits (the first power conversion circuit 11 and the second power conversion circuit 12). Note that, when the single-phase AC power supply is connected, the third power conversion circuit 13 may also be connected to the power supply line L1 to which the AC voltage of the single-phase AC power supply is applied.

Each of the power conversion circuits 11 to 13 has the same configuration and includes, for example, an AC-DC converter that converts an AC voltage into a DC voltage, and a DC-DC converter that converts the DC voltage into a voltage of a predetermined value. Note that each of the power conversion circuits 11 to 13 is not limited to one including both the AC-DC converter and the DC-DC converter, and may include the AC-DC converter alone.

The conversion circuit switching unit 20 includes a noise filter unit 21, a voltage detection unit 22, a switching circuit unit 23, a control unit 24 (an example of a hardware processor), and a storage unit 25 (an example of a memory).

The noise filter unit 21 is closer to the power conversion unit 10 than the switching circuit unit 23 is. The noise filter unit 21 includes a first noise filter 211, a second noise filter 212, and a third noise filter 213. Each of the noise filters 211 to 213 may have the same configuration or may be different from each other.

The first noise filter 211 is provided on the first-phase power supply line L1 of the three-phase AC power supply. The power supply line L1 is connected to the first power conversion circuit 11, so that it can be said that the first noise filter 211 corresponds to the first power conversion circuit 11. Note that the power supply line L1 is an electric wire through which a single-phase current flows in a case where the AC power supply 200 is a single-phase AC power supply and through which a first-phase current flows in a case where the AC power supply 200 is a three-phase AC power supply. The first noise filter 211 includes a capacitor 2111 and a coil 2112. The capacitor 2111 has one end connected to the power supply line L1 and the other end connected to the neutral wire N.

The second noise filter 212 is provided on the second-phase power supply line L2 of the three-phase AC power supply. The power supply line L2 is connected to the second power conversion circuit 12, so that it can be said that the second noise filter 212 corresponds to the second power conversion circuit 12. Note that the power supply line L2 is an electric wire through which a single-phase current flows in a case where the AC power supply 200 is a single-phase AC power supply and through which a second-phase current flows in a case where the AC power supply 200 is a three-phase AC power supply. The second noise filter 212 includes a capacitor 2121 and a coil 2122. The capacitor 2121 has one end connected to the power supply line L2 and the other end connected to the neutral wire N.

The third noise filter 213 is provided on the third-phase power supply line L3 of the three-phase AC power supply. The power supply line L3 is connected to the third power conversion circuit 13, so that it can be said that the third noise filter 213 corresponds to the third power conversion circuit 13. Note that the power supply line L3 is an electric wire through which no current flows in a case where the AC power supply 200 is a single-phase AC power supply and through which a third-phase current flows in a case where the AC power supply 200 is a three-phase AC power supply. The third noise filter 213 includes a capacitor 2131 and a coil 2132. The capacitor 2131 has one end connected to the power supply line L3 and the other end connected to the neutral wire N.

The voltage detection unit 22 detects an AC voltage applied to each of the power supply lines L1 to L3. Specifically, the voltage detection unit 22 includes a first voltage sensor 221, a second voltage sensor 222, and a third voltage sensor 223. The first voltage sensor 221 detects an AC voltage (hereinafter, also referred to as “L1 voltage”) applied between the power supply line L1 and the neutral wire N. The second voltage sensor 222 detects an AC voltage (hereinafter, also referred to as “L2 voltage”) applied between the power supply line L2 and the neutral wire N. The third voltage sensor 223 detects an AC voltage (hereinafter, also referred to as “L3 voltage”) applied between the power supply line L3 and the neutral wire N. Each of the voltage sensors 221 to 223 inputs the detected voltage value to the control unit 24. The voltage detection unit 22 is used for, for example, a case of determining which of a single-phase AC power supply and a three-phase AC power supply is the AC power supply 200 connected to the power supply device 100.

The switching circuit unit 23 switches the phase of the AC power supply 200 connected to the power conversion circuits 11 to 13 on the basis of a control signal output from the control unit 24. The switching circuit unit 23 includes a relay 231 (an example of a relay circuit), a coil 232, a drive circuit 233, and a temperature sensor 234 (an example of a temperature detection circuit).

The relay 231 operates in response to a control signal output from the control unit 24. The relay 231 switches between a first state and a second state. The first state refers to a state where a power supply line of each phase of the multi-phase AC power supply is connected to a corresponding power conversion circuit when a multi-phase AC power supply is connected. The second state refers to a state where a power supply line of the single-phase AC power supply is connected to at least two of the power conversion circuits when a single-phase AC power supply is connected.

More specifically, as illustrated in FIG. 1, the relay 231 is connected to a contact A side in a standby state where the AC power supply 200 is not connected to the power supply device 100. When a three-phase AC power supply is connected to the power supply device 100 in the standby state, the first voltage sensor 221 detects the L1 voltage that is the first-phase AC voltage. In addition, the second voltage sensor 222 detects the L2 voltage that is a second-phase AC voltage, and the third voltage sensor 223 detects the L3 voltage that is a third-phase AC voltage. As a result, the control unit 24 detects the three-phase AC power supply being connected. The control unit 24 then maintains the relay 231 in a state of being connected to the contact A.

At this point, the first phase of the three-phase AC power supply is connected to the first power conversion circuit 11 via the power supply line L1, the second phase of the three-phase AC power supply is connected to the second power conversion circuit 12 via the power supply line L2, and the third phase of the three-phase AC power supply is connected to the third power conversion circuit 13 via the power supply line L3. As a result, the power supply device 100 enters the first state.

Meanwhile, when a single-phase AC power supply is connected to the power supply device 100 in the standby state, the first voltage sensor 221 detects the L1 voltage that is the AC voltage of the single-phase AC power supply. Contrarily, the second voltage sensor 222 and the third voltage sensor 223 do not detect an AC voltage. As a result, the control unit 24 detects the single-phase AC power supply being connected. The control unit 24 then switches the relay 231 to a state of being connected to a contact B side.

At this point, the single-phase AC power supply is connected to the first power conversion circuit 11 via the power supply line L1 and is connected to the second power conversion circuit 12 via the power supply line L1 and the power supply line L2. In other words, the single-phase AC power supply is connected to at least two or more of the power conversion circuits 11 to 13. As a result, the power supply device 100 enters the second state.

As described above, the power supply device 100 can detect the second-phase AC voltage when the three-phase AC power supply is connected thereto by connecting the relay 231 to the contact A side in the standby state. Thus, the power supply device 100 can determine which of a three-phase AC power supply and a single-phase AC power supply is connected.

The drive circuit 233 amplifies a control signal input from the control unit 24 to a value that can drive the relay 231 and applies the control signal to the coil 232. The control signal is a signal for controlling the connection state of the relay 231 and is, for example, a rectangular wave signal having a binary number of a high level or a low level. With the signal amplified by the drive circuit 233 applied to the coil 232, the relay 231 can be switched between the state of being connected to the contact A side and the state of being connected to the contact B side. Note that, in the following description, outputting a high-level control signal for connecting the relay 231 to the contact B side may be simply referred to as “outputting a control signal”.

The temperature sensor 234 is provided in the switching circuit unit 23. The temperature sensor 234 directly or indirectly detects the temperature of the relay 231. The temperature sensor 234 may be directly attached to the relay 231 or may be attached to the drive circuit 233 or others. For example, the temperature sensor 234 can indirectly detect the temperature of the relay 231 by detecting the temperature of the drive circuit 233 highly related to the temperature of the relay 231. The temperature sensor 234 is an example of a temperature detection unit (or a temperature detection circuit) that is configured to detect the temperature of the relay 231.

Hereinafter, the relationship between timing at which the relay 231 is switched from the contact A side to the contact B side (hereinafter, also referred to as “switching timing of the relay 231”) and the inrush current flowing into the relay 231 will be described.

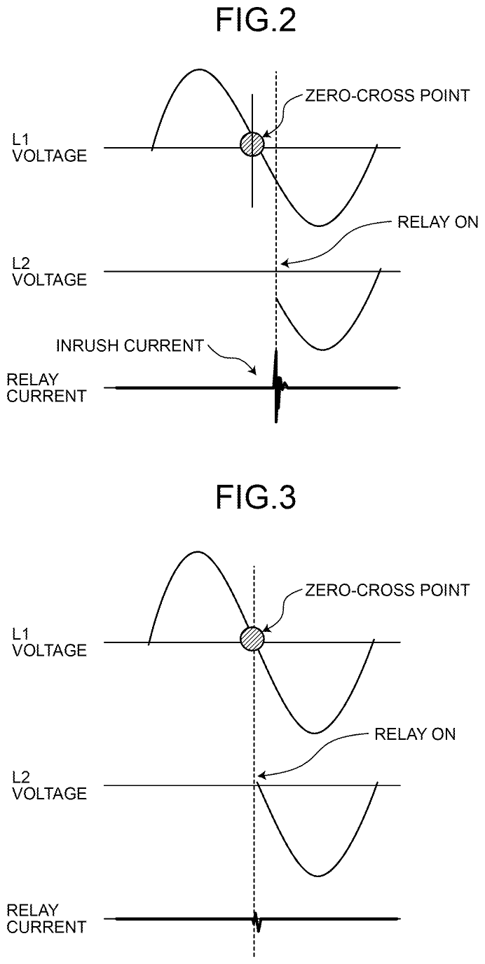

FIGS. 2 and 3 are diagrams illustrating the L1 voltage, the L2 voltage, and the inrush current (hereinafter, also simply referred to as “inrush current”) flowing into the relay 231 when the power supply device 100 is switched from the first state to the second state.

In FIG. 2, a waveform of the inrush current is illustrated. The inrush current flows into the relay 231 when the switching timing of the relay 231 has passed, for example, by several milliseconds (msec) from the zero-cross point of the L1 voltage. In this case, when the relay 231 is switched to the contact B side, the AC voltage of the single-phase AC power supply is applied to the power supply line L2, and a charge charged in the capacitor 2111 of the first noise filter 211 flows into the capacitor 2121 of the second noise filter 212. As a result, a large inrush current flows into the relay 231.

In FIG. 3, a waveform of the inrush current is illustrated. The inrush current flows into the relay 231 in a case where the switching timing of the relay 231 is close to the zero-cross point of the L1 voltage. In this case, when the relay 231 is switched to the contact B side, the AC voltage of the single-phase AC power supply applied to the power supply line L2 is almost 0 (V), and there is almost no difference in voltage between both ends of the capacitor 2111 of the first noise filter 211. Therefore, the inrush current flowing into the relay 231 is suppressed.

The power supply device 100 according to the embodiment is configured to control the output timing of the control signal in such a manner that the relay 231 is switched to the contact B side close to the zero-cross point of the L1 voltage, thereby suppressing the inrush current flowing into the relay 231.

Returning to FIG. 1, the configuration of the power supply device 100 will be described. The control unit 24 is implemented by, for example, a computer including a processor such as a central processing unit (CPU), a read only memory (ROM), a random access memory (RAM), and others.

The control unit 24 outputs a control signal to the drive circuit 233 in order to control the operation of the relay 231. For example, the control unit 24 controls the output timing of the control signal in such a manner that the switching timing of the relay 231 coincides with the zero-cross point of the AC voltage (L1 voltage) of the single-phase AC power supply. The control unit 24 outputs the control signal to the drive circuit 233. The control unit 24 determines the output timing of the control signal on the basis of temperature characteristic information (to be described later) stored in the storage unit 25.

The operation time of the relay 231 to be considered for setting the switching timing of the relay 231 close to the zero-cross point of the L1 voltage will be described. It is known that the operation time varies with individual differences of the relay 231. The variation in the operation time due to the individual differences has a relatively large influence on the switching timing of the relay 231. Therefore, in the related art, the output timing of the control signal is adjusted for each individual relay such that the switching timing of the relay 231 is close to the zero-cross point of the L1 voltage.

However, the operation time of the relay 231 is affected not only by variations due to individual differences but also by temperature. That is, the relay 231 has temperature characteristics, and the operation time varies with the environmental temperature at which the relay is used even for the same individual relay.

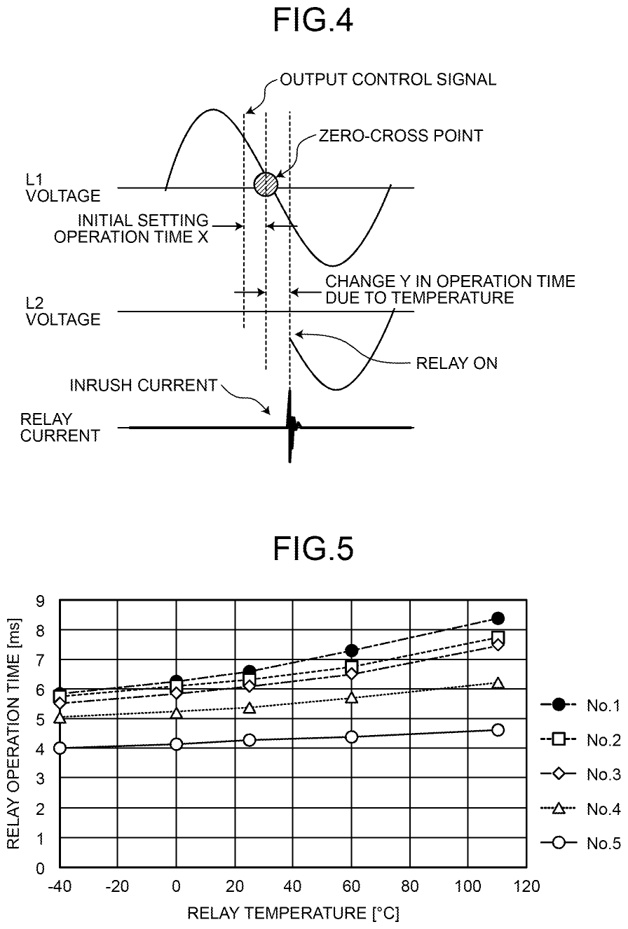

FIG. 4 is a diagram for explaining occurrence of an inrush current due to a change in the operation time of the relay 231. In FIG. 4, the output timing of the control signal is set to timing earlier than the zero-cross point by an initial setting operation time X in consideration of the operation time of the relay 231, the processing times of the control unit 24 and the drive circuit 233, and others.

In a case where the environmental temperature at which the power supply device 100 is used is high and the temperature of the relay 231 is high, the operation time changes with the temperature. As a result, the switching timing of the relay 231 is delayed from the zero-cross point of the L1 voltage, and an inrush current flows into the relay 231.

Considering the above, the power supply device 100 of the present embodiment suppresses the inrush current flowing into the relay 231 by determining the output timing of the control signal in consideration of not only the variations in the operation time due to the individual difference of the relay 231 but also the temperature characteristics of the relay 231.

FIG. 5 is a diagram illustrating operation time temperature characteristics of each individual relay 231 used in the power supply device 100. Note that the operation time herein referred to includes the processing time of the control unit 24 and the drive circuit 233. In the example of FIG. 5, the operation times measured by changing the temperature for five individual relays are illustrated.

For example, in the case of a relay 231 of individual relay No. 5, the operation time is about 4.3 (msec) at a relay temperature of 60° C. Therefore, when the relay 231 of individual relay No. 5 is used at 60° C., the control unit 24 outputs the control signal at timing 4.3 (msec) earlier than the zero-cross point of the L1 voltage. This makes it possible for the control unit 24 to set the switching timing of the relay 231 close to the zero-cross point of the L1 voltage that is the voltage of the single-phase AC power supply.

Therefore, it is desirable that the temperature characteristics of all the relays 231 used in power supply devices 100 are measured before shipment and that the control unit 24 controls the output timing of the control signal on the basis of the temperature characteristics in the actual use state. However, it is not realistic to measure the temperature characteristics of all the relays 231 used in the power supply devices 100 to be commercialized.

Considering the above, in the present embodiment, five individual patterns illustrated in FIG. 5 are set, and the temperature characteristics of an individual pattern approximate to that of a relay 231 used for a power supply device 100 is selected in advance before shipment. For example, for a relay 231 used in a product, the operation time can be measured at several predetermined temperatures before shipment, and temperature characteristics of an individual pattern closest to the measured operation time can be selected. Note that it is a matter of course that the temperature characteristics of all the relays 231 in use may be measured before shipment and that the output timing of the control signal may be controlled on the basis of the temperature characteristics.

The storage unit 25 stores temperature characteristic information by which the temperature of the relay 231 is correlated with the operation time of the relay 231. Specifically, the storage unit 25 stores five temperature characteristic tables 241 to 245, each correlating the temperature of a relay 231 and the operation time of the relay 231 with each other. The temperature characteristic tables 241 to 245 are each an example of the temperature characteristic information stored in the storage unit 25. The temperature characteristic tables 241 to 245 correspond to the temperature characteristics of the patterns of items No. 1 to No. 5 in FIG. 5, respectively.

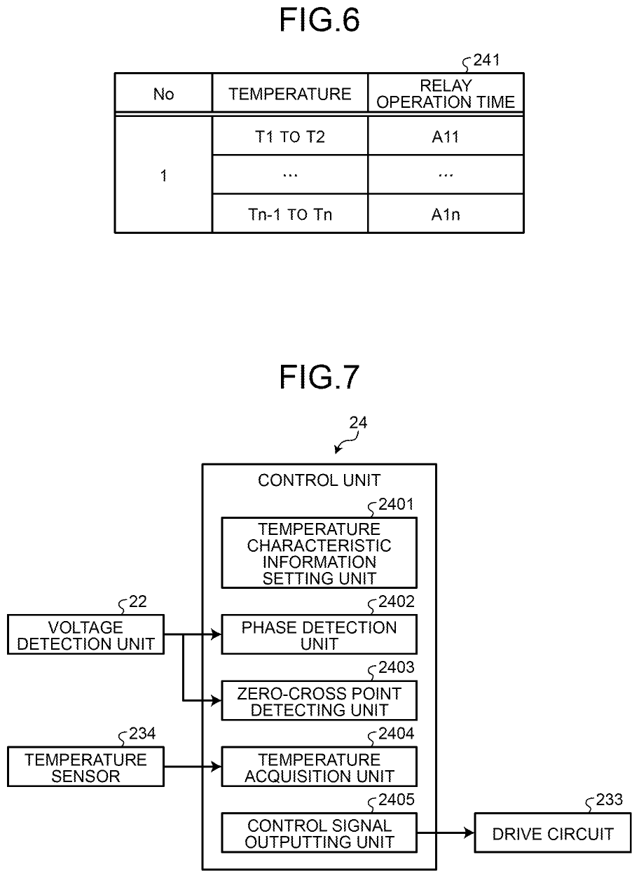

FIG. 6 is a table illustrating the temperature characteristic table 241 stored in the storage unit 25. The temperature characteristic table 241 stores items including a table number (No.), a temperature, and a relay operation time to correlate them with each other. The table number is a number used for identifying the temperature characteristic table. The temperature indicates a temperature range of the relay 231. The relay operation time indicates the operation time of the relay 231 at the corresponding temperature. Since the other temperature characteristic tables 242 to 245 have a similar structure as that of the temperature characteristic table 241, redundant description will be omitted.

Note that, in a case where the temperature characteristics are considered without considering variations due to individual differences of the relay 231, it is sufficient to use one of the temperature characteristic tables 241 to 245 stored in the storage unit 25. The temperature characteristic information stored in the storage unit 25 may not be the temperature characteristic table and may be a mathematical formula or the like for calculating the operation time of the relay 231 by using the temperature.

Next, the functional configuration of the control unit 24 will be described. FIG. 7 is a block diagram illustrating the functional configuration of the control unit 24. The control unit 24 functions as a temperature characteristic information setting unit 2401, a phase detection unit 2402, a zero-cross point detecting unit 2403, a temperature acquisition unit 2404, and a control signal outputting unit 2405, by the CPU operating in accordance with a control program stored in the ROM. Note that the functional configurations described above may be implemented by a hardware configuration such as a dedicated circuit.

The temperature characteristic information setting unit 2401 sets one of the temperature characteristic tables 241 to 245 stored in the storage unit 25, as the temperature characteristic information for determining the output timing of the control signal in the actual use state. For example, the temperature characteristic information setting unit 2401 sets one of the temperature characteristic tables 241 to 245 as the temperature characteristic information in the actual use state on the basis of input from an operation unit (not illustrated). The temperature characteristic information setting unit 2401 sets the temperature characteristic information, generally, before shipment of the power supply device 100.

The phase detection unit 2402 detects the AC power supply 200 being connected to the power supply device 100, on the basis of a voltage value acquired from the voltage detection unit 22. Specifically, when information indicating an AC voltage is input from one of the first voltage sensor 221, the second voltage sensor 222, and the third voltage sensor 223, the phase detection unit 2402 detects the AC power supply 200 being connected to the power supply device 100.

In addition, the phase detection unit 2402 determines which of a single-phase AC power supply and a three-phase AC power supply is the AC power supply 200 connected to the power supply device 100. Specifically, when the AC power supply 200 is connected and information indicating the AC voltage is input from all the first voltage sensor 221, the second voltage sensor 222, and the third voltage sensor 223, the phase detection unit 2402 detects the AC power supply 200 being a three-phase AC power supply.

In a case where information indicating the AC voltage is input from the first voltage sensor 221 and no information indicating the AC voltage is input from the second voltage sensor 222 and the third voltage sensor 223 when the AC power supply 200 is connected, the phase detection unit 2402 detects the AC power supply 200 being a single-phase AC power supply.

The zero-cross point detecting unit 2403 detects zero-cross points of the L1 voltage, the L2 voltage, and the L3 voltage on the basis of the information indicating the AC voltage input from the first voltage sensor 221, the second voltage sensor 222, and the third voltage sensor 223. Note that the zero-cross point detecting unit 2403 may detect the zero-cross point of the L1 voltage alone.

The temperature acquisition unit 2404 acquires the temperature of the relay 231 directly or indirectly detected by the temperature sensor 234.

The control signal outputting unit 2405 determines output timing of the control signal for switching the relay 231 and outputs the control signal to the drive circuit 233 at the determined timing. For example, in a case where a single-phase AC power supply is connected, the control signal outputting unit 2405 makes reference to the temperature characteristic table set by the temperature characteristic information setting unit 2401 and reads the relay operation time corresponding to the temperature acquired by the temperature acquisition unit 2404. Then, the control signal outputting unit 2405 determines the output timing of the control signal on the basis of the relay operation time that has been read out and other factors affecting the output timing. For example, the control signal outputting unit 2405 determines the output timing of the control signal on the basis of the relay operation time that has been read out, the frequency of the AC power supply 200, and others. The frequency of the AC power supply 200 is detected by a frequency detection unit (not illustrated). The output timing of the control signal is defined by a time period from the zero-cross point of the AC power supply voltage. The control signal outputting unit 2405 outputs the control signal to the drive circuit 233 at the determined output timing.

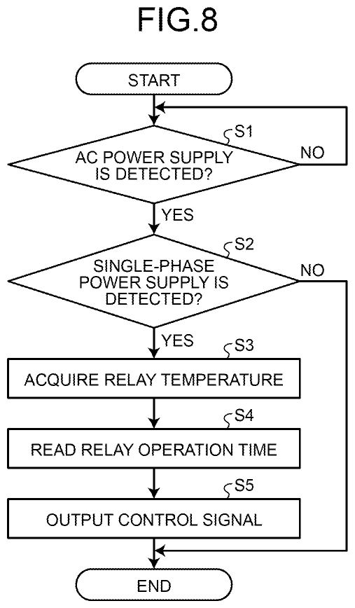

Next, relay switching processing executed by the control unit 24 when the AC power supply 200 is connected to the power supply device 100 will be described. FIG. 8 is a flowchart illustrating a flow of relay switching processing by the control unit 24.

First, the control unit 24 determines whether the phase detection unit 2402 has detected the AC power supply 200 (step S1). In response to determining that no AC power supply 200 is detected (No in step S1), the control unit 24 returns to the processing of step S1 and waits. When the phase detection unit 2402 detects the AC power supply 200 (Yes in step S1), the control unit 24 determines whether or not the phase detection unit 2402 has detected a single-phase AC power supply (step S2).

In response to determining that the phase detection unit 2402 does not detect a single-phase AC power supply (No in step S2), in other words, when the phase detection unit 2402 detects a three-phase AC power supply, the control unit 24 ends the relay switching processing. With this operation, the relay 231 is maintained in the standby state of being connected to the contact A side, and the power supply device 100 is maintained in the first state.

When the phase detection unit 2402 detects the single-phase AC power supply (Yes in step S2), the temperature acquisition unit 2404 acquires the relay temperature from the temperature sensor 234 (step S3). The control signal outputting unit 2405 makes reference to the temperature characteristic table, which has been preset by the temperature characteristic information setting unit 2401 from among the temperature characteristic tables 241 to 245, and reads the relay operation time corresponding to the relay temperature acquired by the temperature acquisition unit 2404 (step S4).

Subsequently, the control signal outputting unit 2405 outputs the control signal to the drive circuit 233 at the output timing that is determined on the basis of the relay operation time having been read out (step S5). The control signal outputting unit 2405 outputs the control signal at the output timing determined on the basis of the zero-cross point of the L1 voltage detected by the zero-cross point detecting unit 2403. With this operation, the relay 231 is switched to the contact B side, and the power supply device 100 is switched to the second state. Then, the control unit 24 ends the switching processing.

Through the switching processing described above, the control unit 24 is able to change the output timing of the control signal to be output to the drive circuit 233 in accordance with the temperature of the relay 231.

As described above, the power supply device 100 according to the present embodiment is connectable to a single-phase AC power supply or a multi-phase AC power supply. The power supply device 100 includes the power conversion circuits 11 to 13, each corresponding to a different one of phases of the multi-phase AC power supply. The power supply device 100 includes the relay 231, the noise filters 211 to 213, the temperature sensor 234, and the control unit 24. The relay 231 is capable of switching between the first state and the second state. The first state is a state where the power supply lines L1 to L3 of the phases of the multi-phase AC power supply are connected to the corresponding respective power conversion circuits. The second state is a state where the power supply line L1 of the single-phase AC power supply is connected to at least two of the power conversion circuits 11 to 13. Each of the noise filters 211 to 213 includes a capacitor and is positioned closer to the power conversion circuits 11 to 13 than the relay 231 is. The noise filters 211 to 213 correspond to the power conversion circuits 11 to 13, respectively. The temperature sensor 234 detects the temperature of the relay 231. The control unit 24 controls the output timing of the control signal for operating the relay 231 on the basis of the temperature detected by the temperature sensor 234 in such a manner that the first state is switched to the second state at the timing when an AC voltage of the single-phase AC power supply crosses zero.

With the configuration above, when the single-phase AC power supply is connected to the power supply device 100 and the relay 231 is switched from the contact A side to the contact B side, the switching timing of the relay 231 can be set close to the zero-cross point of the L1 voltage regardless of the temperature of the relay 231. It is possible to suppress the inrush current flowing into the relay 231 regardless of the environmental temperature at which the relay 231 is used. It is possible to prevent a failure of the relay 231 due to adhesion to the contact or others caused by a large inrush current.

### Second Embodiment

Next, a power supply device 100 according to a second embodiment will be described. In the first embodiment, the output timing of the control signal is determined in consideration of the temperature of the relay 231 in the actual use state. In the second embodiment, the output timing at next use is determined in consideration of various factors in the situation of use. Therefore, it can be said that the power supply device 100 of the second embodiment is suitable for a case where the power supply device is used in a situation where the use environment does not change much. Note that, in the following description, description of configurations and functions similar to those of the power supply device 100 of the first embodiment may be omitted.

The circuit configuration of the power supply device 100 is similar to that of the first embodiment illustrated in FIG. 1. A storage unit 25 stores a default value of output timing of a control signal. The output timing of the control signal is defined by a time difference from a zero-cross point of an AC voltage. The default value is determined in advance in consideration of, for example, an average value of the operation time of a relay 231, a predetermined environmental temperature, and others. For example, two or more default values are stored in advance in the storage unit 25 for each frequency of the AC power supply voltage, and a default value to be used as the output timing is selected on the basis of a detection result of a frequency detection unit (not illustrated) serving to detect the frequency of the AC power supply voltage. Note that only one default value may be stored in the storage unit 25, and the output timing to be used may be calculated from the frequency detected by the frequency detection unit and the one default value.

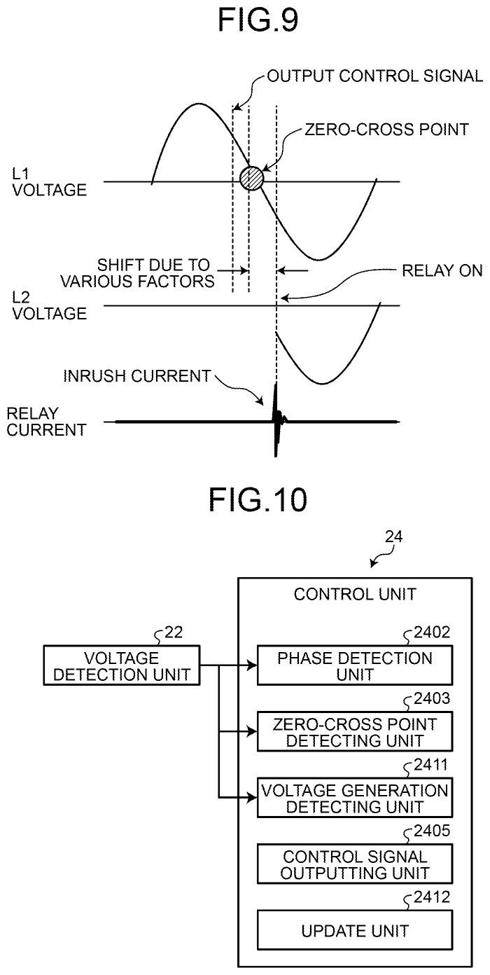

Hereinafter, the relationship between the switching timing of the relay 231 and the inrush current flowing into the relay 231 in the second embodiment will be described. FIG. 9 is a diagram for explaining occurrence of the inrush current and illustrates, for example, a case where a control signal is output at the output timing of a default value.

In the example of FIG. 9, the timing at which the L2 voltage is generated after switching from the first state to the second state, in other words, the switching timing of the relay 231, is shifted by several milliseconds (msec) from the zero-cross point of an L1 voltage. As a result, an inrush current flows into the relay 231. The shift of the switching timing from the zero-cross point is caused by various factors such as an individual difference of the relay 231, an ambient temperature, and aging deterioration of the relay 231. In the present embodiment, the shift from the zero-cross point caused by the various factors is corrected to suppress the inrush current in a next approximated actual use state.

Next, the functional configuration of a control unit 24 will be described by referring to FIG. 10. The control unit 24 functions as a phase detection unit 2402, a zero-cross point detecting unit 2403, a voltage generation detecting unit 2411, a control signal outputting unit 2405, and an update unit 2412 by a CPU operating in accordance with a control program stored in a ROM. Note that the functional configurations described above may be implemented by a hardware configuration such as a dedicated circuit.

The functions of the phase detection unit 2402, the zero-cross point detecting unit 2403, and the control signal outputting unit 2405 are similar to those of the first embodiment.

The voltage generation detecting unit 2411 detects generation timing of a voltage newly input to a second power conversion circuit 12 when the first state is switched to the second state. Specifically, the voltage generation detecting unit 2411 detects timing at which a voltage is generated in a power supply line L2, on the basis of information indicating an AC voltage that is input from a second voltage sensor 222 of a voltage detection unit 22. The timing at which the voltage is generated in the power supply line L2 is defined by a time difference from the zero-cross point of the L1 voltage. The voltage generation detecting unit 2411 substantially detects the switching timing of the relay 231 by detecting the timing at which a voltage is generated in the power supply line L2.

The update unit 2412 updates the output timing stored in the storage unit 25 on the basis of the generation timing of the voltage detected by the voltage generation detecting unit 2411. For example, the update unit 2412 calculates the time difference between the zero-cross point of the L1 voltage and the generation timing of the voltage detected by the voltage generation detecting unit 2411. The update unit 2412 then corrects a default value of the output timing stored in the storage unit 25 by the time difference that has been calculated. The update unit 2412 corrects and updates the output timing stored in the storage unit 25 every time the power supply device 100 is used.

Note that the update unit 2412 may store two or more updated output timings. In this case, the update unit 2412 may store the place of use, the date and time of use, and the like of the power supply device 100 while correlating them with the updated output timing. With this configuration, in a case where the power supply device 100 is used in an actual use state that approximates to that in a past, the output timing of the control signal that has been stored in the past can be read and set as the output timing.

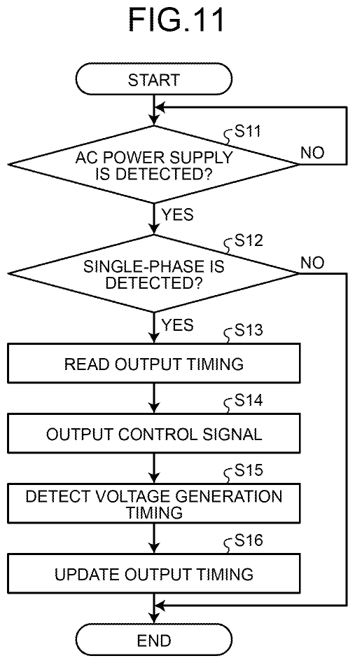

Next, relay switching processing executed by the control unit 24 will be described. FIG. 11 is a flowchart illustrating a flow of relay switching processing by the control unit 24.

The control unit 24 determines whether or not the phase detection unit 2402 has detected the AC power supply 200 (step S11). In response to determining that no AC power supply 200 is detected (No in step S11), the control unit 24 returns to the processing of step S11 and waits. When the phase detection unit 2402 detects the AC power supply 200 (Yes in step S11), the control unit 24 determines whether or not the phase detection unit 2402 has detected a single-phase AC power supply (step S12).

In response to determining that the phase detection unit 2402 does not detect a single-phase AC power supply (No in step S12), in other words, when the phase detection unit 2402 detects a three-phase AC power supply, the control unit 24 ends the relay switching processing. As a result, the relay 231 is maintained in the standby state of being connected to the contact A side, and the power supply device 100 is maintained in the first state.

When the phase detection unit 2402 detects a single-phase AC power supply (Yes in step S12), the control signal outputting unit 2405 reads the output timing from the storage unit 25 (step S13). Subsequently, the control signal outputting unit 2405 outputs the control signal to the drive circuit 233 at the output timing obtained in step S13 (step S14). As a result, the relay 231 is switched to the contact B side, and the power supply device 100 is switched to the second state.

The voltage generation detecting unit 2411 detects the timing at which the voltage is generated in the power supply line L2, on the basis of the information from the second voltage sensor 222 (step S15). Next, the update unit 2412 calculates the time difference between the timing at which the voltage is generated in the power supply line L2 and the zero-cross point of the L1 voltage, and stores the time difference in the storage unit 25. The output timing stored in the storage unit 25 is updated (step S16). Then, the control unit 24 ends the relay switching processing.

Through the switching processing described above, the control unit 24 can update the output timing stored in the storage unit 25 in accordance with the actual use state.

As described above, the power supply device 100 according to the present embodiment is connectable to a single-phase AC power supply or a multi-phase AC power supply. The power supply device 100 includes the power conversion circuits 11 to 13, each corresponding to a different one of phases of the multi-phase AC power supply. The power supply device 100 includes the relay 231, the noise filters 211 to 213, the storage unit 25, the control unit 24, the voltage generation detecting unit 2411, and the update unit 2412. The relay 231 is capable of switching between the first state and the second state. The first state is a state where the power supply lines L1 to L3 of the respective phases of the multi-phase AC power supply are connected to the respective power conversion circuits 11 to 13. The second state is a state where the power supply line L1 of the single-phase AC power supply is connected to at least two of the power conversion circuits 11 to 13. Each of the noise filters 211 to 213 includes a capacitor and is positioned closer to the power conversion circuits 11 to 13 than the relay 231 is. The noise filters 211 to 213 correspond to the power conversion circuits 11 to 13, respectively. The storage unit 25 stores information representing the output timing of the control signal for switching from the first state to the second state by operating the relay 231. The control unit 24 outputs the control signal on the basis of the output timing stored in the storage unit 25. The voltage generation detecting unit 2411 detects generation timing of a voltage newly input to the second power conversion circuit 12 connected to the power supply line L1 of the single-phase AC power supply when the first state is switched to the second state. The update unit 2412 updates the output timing stored in the storage unit 25 on the basis of the generation timing of the voltage detected by the voltage generation detecting unit 2411.

With the configuration above, the power supply device 100 is able to update the output timing of the control signal stored in the storage unit 25 on the basis of various factors in the actual use state. Therefore, if the actual use state is similar in the next use, it is possible to suppress an inrush current flowing into the relay 231 when the first state is switched to the second state. Therefore, it is possible to prevent a failure of the relay 231 due to adhesion to the contact or others caused by a large inrush current.

Although the embodiments of the present disclosure have been described above, the present invention is not limited to the above-described embodiments, and various modifications can be made without departing from the gist of the present invention.

For example, the configuration of the power supply device 100 may be a combination of the first embodiment and the second embodiment. That is, the output timing of the control signal may be determined on the basis of the temperature of the relay 231 when the power supply device 100 is used, and the temperature characteristic table 241 may be corrected on the basis of the shift between the zero-cross point of the L1 voltage generated at this point and the switching timing of the relay 231.

Note that a computer program executed by the power supply device 100 in each of the above embodiments is provided in a state of being incorporated in the ROM or the like in advance. The computer program executed in the power supply device 100 may be recorded as a file in an installable format or an executable format in a computer-readable storage medium such as a CD-ROM, a flexible disk (FD), a CD-R, or a digital versatile disk (DVD) and thereby provided. Moreover, the computer program may be provided to the power supply device 100 via a network such as the Internet.

What is claimed is:

1. A power supply device connectable to a single-phase AC power supply or a multi-phase AC power supply, the power supply device comprising:
power conversion circuits, each corresponding to a different one of phases of the multi-phase AC power supply;
a relay circuit capable of switching between a first state and a second state, the first state being a state where a power supply line of each of the phases of the multi-phase AC power supply is connected to a corresponding power conversion circuit, the second state being a state where a power supply line of the single-phase AC power supply is connected to at least two of the power conversion circuits;
noise filter circuits, each including a capacitor and being positioned closer to the power conversion circuits than the relay circuit is, each of the noise filter circuits corresponding to a different one of the power conversion circuits;
a temperature detection circuit configured to detect a temperature of the relay circuit; and
a hardware processor configured to control output timing of a control signal for operating the relay circuit on the basis of the temperature detected by the temperature detection circuit, the output timing being controlled such that the first state is switched to the second state at timing when an AC voltage of the single-phase AC power supply crosses zero.

2. The power supply device according to claim 1, further comprising a memory configured to store one or more pieces of temperature characteristic information, each correlating a temperature of the relay circuit with an operation time of the relay circuit corresponding to the temperature,
wherein the hardware processor is configured to determine the output timing of the control signal on the basis of an operation time of the relay circuit corresponding to the temperature detected by the temperature detection circuit in the temperature characteristic information.

3. The power supply device according to claim 2, wherein
the one or more pieces of temperature characteristic information stored in the memory are multiple pieces of temperature characteristic information, and
the hardware processor is configured to select one of the multiple pieces of temperature characteristic information.

4. A power supply device connectable to a single-phase AC power supply or a multi-phase AC power supply, the power supply device comprising:
power conversion circuits, each corresponding to a different one of phases of the multi-phase AC power supply;
a relay circuit capable of switching between a first state and a second state, the first state being a state where a power supply line of each of the phases of the multi-phase AC power supply is connected to a corresponding power conversion circuit, the second state being a state where a power supply line of the single-phase AC power supply is connected to at least two of the power conversion circuits;
noise filter circuits, each including a capacitor and being positioned closer to the power conversion circuits than the relay circuit is, each of the noise filter circuits corresponding to a different one of the power conversion circuits;
a memory configured to store information representing output timing of a control signal for switching from the first state to the second state by operating the relay circuit;
a hardware processor configured to output the control signal on the basis of the information representing the output timing stored in the memory;
a voltage generation detecting circuit configured to detect generation timing of a voltage newly input to a power conversion circuit connected to the power supply line of the single-phase AC power supply, the generation timing being detected when the first state is switched to the second state; and
an update circuit configured to update the information representing the output timing stored in the memory on the basis of the generation timing of the voltage detected by the voltage generation detecting circuit.

5. The power supply device according to claim 4, wherein the update circuit is configured to:
calculate a time difference between timing at which the AC voltage of the single-phase AC power supply crosses zero and the timing detected by the voltage generation detecting circuit; and
corrects, by the time difference, the information representing the output timing stored in the memory.
